(19) United States
(12) Patent Application Publication
(10) Pub. No.: US 2017/0016225 A1
(43) Pub. Date: Jan. 19, 2017

(54) AIRFLOW MONITOR FOR USE WTH A VACUUM POWERED SEWER SYSTEM

(71) Applicants: Michael Bodenhafer, Kendallville, IN (US); Taylor M. Ramsay, Kendallville, IN (US)

(72) Inventors: Michael Bodenhafer, Kendallville, IN (US); Taylor M. Ramsay, Kendallville, IN (US)

(21) Appl. No.: 15/211,472

(22) Filed: Jul. 15, 2016

Related U.S. Application Data
(60) Provisional application No. 62/193,791, filed on Jul. 17, 2015.

(51) Int. Cl. E03F 1/00; F16K 37/00; F16K 51/02

(52) U.S. Cl. CPC E03F 1/006; F16K 51/02; F16K 37/0033; E03F 2201/40

(57) ABSTRACT

A vacuum sewer system including at least one home collection system, a central vacuum system coupled to the home collection system and a vacuum valve monitoring system coupled to the home collection system. The vacuum valve monitoring system has an airflow detector and an indicator operatively coupled to the airflow detector, the indicator being configured to emanate an indication that the airflow detector has detected an airflow.

### CROSS REFERENCE TO RELATED APPLICATIONS

This is a non-provisional patent application based on U.S. Provisional Application Ser. No. 62/193,791, entitled “AIRFLOW MONITOR FOR USE WITH A VACUUM POWERED SEWER SYSTEM”, filed Jul. 17, 2015, which is incorporated herein by reference.

### BACKGROUND OF THE INVENTION

1. Field of the Invention

The present invention relates to a monitoring device to detect a defective or stuck vacuum operated valve of a vacuum sewer system.

2. Description of the Related Art

A vacuum sewer system is a method of transporting sewage from its source to a sewage treatment plant using negative air pressure. It uses the difference between atmospheric pressure and a partial vacuum maintained in the piping network and vacuum station collection vessel. This differential pressure allows a central vacuum station to collect the wastewater of individual homes.

The main components of a vacuum sewer system are collection chambers and vacuum valves, sewers, a central vacuum station and monitoring and control components.

Vacuum technology is based on differential air pressure. Rotary vane vacuum pumps generate an operation pressure of −0.4 to −0.6 bar at the vacuum station, which is also the only element of the vacuum sewerage system that must be supplied with electricity. Interface valves, that are installed inside the collection chambers, work pneumatically. Sewage flows by means of gravity into each house's collection sump, after a certain fill level inside this sump is reached, the interface valve opens. The impulse to open the valve is usually transferred by a pneumatically (pneumatic pressure created by fill level) controlled controller unit. No electricity is needed to open or close the valve—the energy is provided by the vacuum itself. While the valve is open, the resulting differential pressure becomes the driving force and transports the wastewater towards the vacuum station. When the level of wastewater is lowered to a predetermined level the valve closes to stop the flow of air and wastewater until the level rises enough to trigger the opening of the valve again. Each collection sump has a vent pipe that extends up from the sump so that an unhindered flow of air can enter the sump when the valve is actuated. If the valve does not completely seal there is a flow of air that is effectively an inefficiency in the system since energy is needed to run the vacuum pump.

Once the wastewater arrives in the vacuum collection tank at the vacuum station, the wastewater is then pumped to the discharge point, which may be a gravity sewer or a treatment facility.

A weakness of the system lies in the functioning of the valves. The mechanical float switches that operate the valves require preventative maintenance for worn parts and seals. Also, the vacuum valves can get stuck open leading to pressure drops in the entire system. One technique to detect the stuck or non-closing valve is to walk up to a vent pipe and listen to hear a continuous flow of air. This is time consuming in that it has to be done for each sump at each home until the stuck valve(s) is (are) discovered.

What is needed in the art is an effective monitoring system that allows for the determination of the functioning of the valve from a distance.

### SUMMARY OF THE INVENTION

The present invention provides a monitoring device to detect a defective or stuck vacuum operated valve of a vacuum sewer system.

The invention in one form is directed to a vacuum sewer system including at least one home collection system, a central vacuum system coupled to the home collection system and a vacuum valve monitoring system coupled to the home collection system. The vacuum valve monitoring system has an airflow detector and an indicator operatively coupled to the airflow detector, the indicator being configured to emanate an indication that the airflow detector has detected an airflow thereby.

The invention in another form is directed to a vacuum valve monitoring system that is coupled to at least one home collection system of a central vacuum system. The vacuum valve monitoring system has an airflow detector and an indicator operatively coupled to the airflow detector, the indicator being configured to emanate an indication that the airflow detector has detected an airflow.

An advantage of the present invention is that the functioning of a vacuum valve can be determined at a distance from the vent pipe, no longer requiring a person to listen for the flow of air

Another advantage of the present invention is that the airflow monitor is easily installed in existing vent pipes.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematical view of a vacuum sewer system using an embodiment of a valve monitoring system of the present invention;

FIG. 2 is a closer side view of the valve monitoring system of FIG. 1;

FIG. 3 illustrates a closer view of the airflow monitor or valve monitoring system itself of FIGS. 1 and 2;

FIG. 4 is a partially sectioned side view of the airflow monitor of FIG. 3;

FIG. 5 is a partially exploded schematical view of parts of the airflow monitor of FIGS. 1-4; and

FIG. 6 is a block diagram of the functional components of the airflow monitor of FIGS. 1-5.

Corresponding reference characters indicate corresponding parts throughout the several views. The exemplification set out herein illustrates embodiment of the invention, in one form, and such exemplification is not to be construed as limiting the scope of the invention in any manner.

### DETAILED DESCRIPTION OF THE INVENTION

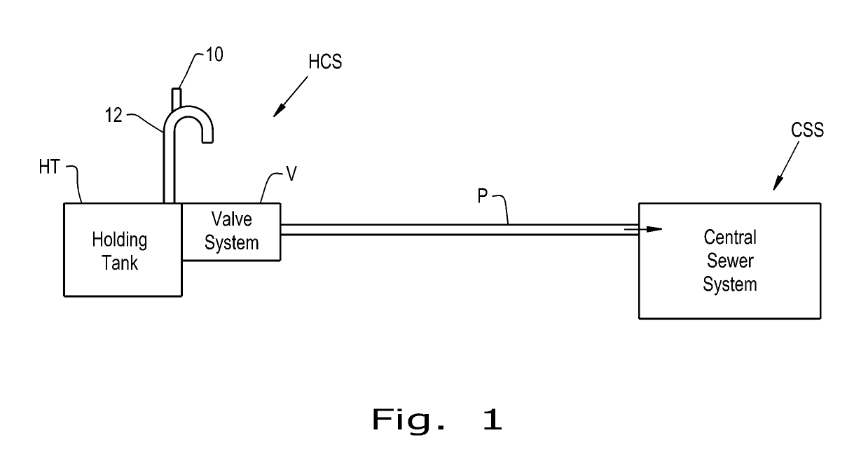

Referring now to the drawings, and more particularly to FIG. 1, there is shown a home collection system HCS coupled to a central sewer system CSS. Multiple home collection systems HCS are coupled to the central sewer system CSS. An airflow monitor 10 or vacuum valve monitoring system 10 of the present invention is installed in a typical vent pipe 12 connected to a holding tank or sump HT. Airflow monitor 10 is installed through a sidewall of vent pipe 12 and may be glued in place or may be mechanically secured, for example by being threaded thereto.

Central system CSS includes a vacuum system that provides a vacuum in pipe P. When the level of wastewater in holding tank HT achieves a predetermined level then valve V opens and the vacuum in pipe P pulls the wastewater from holding tank HT to central system CSS. Air flows into holding tank HT by way of vent pipe 12 until valve V closes when the level of wastewater in holding tank HT is lowered. Airflow monitor 10 detects the flow of air through vent pipe 12 and provides a signal when the airflow is occurring as discussed herein.

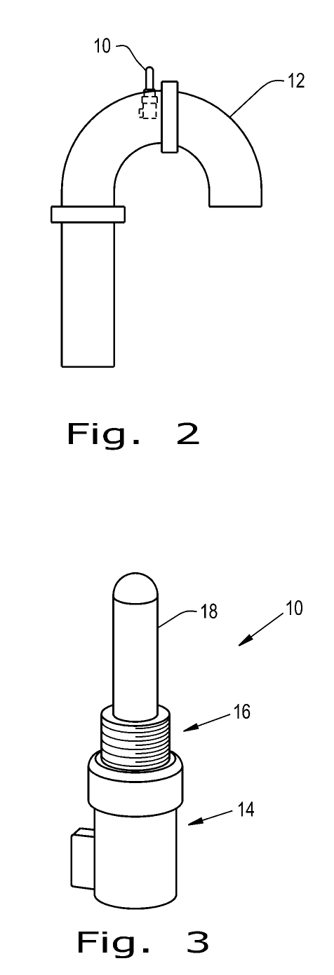

Now, additionally referring to FIG. 2 there is shown a closer view of vent pipe 12 with airflow monitor 10 installed therein. Airflow monitor 10 can be easily installed in existing vent pipes 12 by drilling a hole through the side of pipe 12 inserting monitor 10 from the inside of pipe 12 through the hole and threading a nut on the threaded portion of monitor 10.

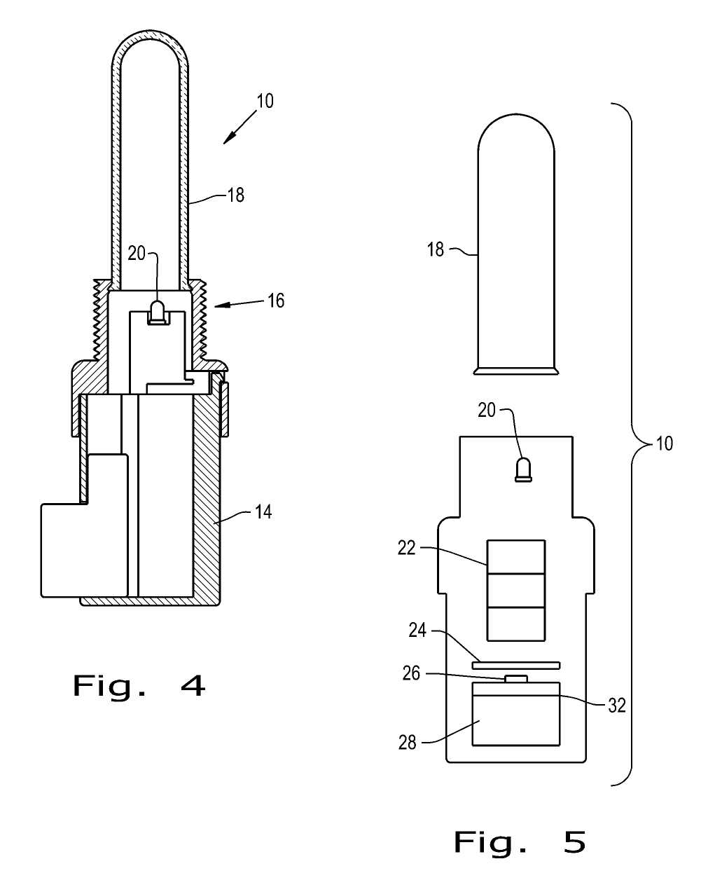

Now, additionally referring to FIGS. 3-5, there are shown more details of airflow monitor 10, which includes a base unit 14, a securing means 16, and a light diffuser or refractor 18.

In base unit 14 there is an LED light 20, a battery pack 22, a Reed switch 24, a magnet 26 and a flapper 28. When an airflow moves past flapper 28, which may be a diaphragm 28 it cause magnet 26 connected thereto to move, which in turn causes reed switch 24 to electrically close and conduct electricity from battery pack 22 to LED light 20. Reed switch 24 along with magnet 26 and flapper 28 can be considered a sensor, which may be an integral unit. LED light 20 may be constantly illuminated or blink in a specific pattern to indicate the flow of air. This then allows the leaky valve V to be easily found and corrected.

During normal operation whenever the valve V is activated and there is an airflow then LED light 20 will illuminate. Since normal operation will then have the valve closing in a few seconds the constant activation (whether blinking or solidly illuminated) provides an alert that maintenance is needed.

It is also contemplated that a timing circuit 30, as depicted in FIG. 6 may delay the activation of light 20 until a predetermined time, such as 20 seconds, 30 seconds or 1 minute, or some other predetermined time has passed. This allows airflow monitor 10 to never illuminate indicator 20 during normal operation of the sump and valve V.

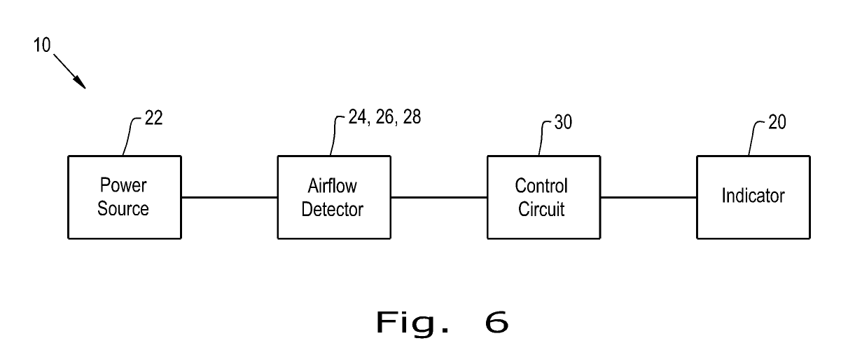

FIG. 5 functionally illustrates the circuitry that effects the action described above. Here diaphragm 28 is pivotal about line 30, so that airflow will cause diaphragm 28 to move about pivot 32 to cause the activation of airflow monitor 10 as described above.

It is also contemplated that a solar power cell may be used to provide power to battery pack 22 to maintain the operating condition thereof. It is further contemplated that some alternative alerting technique may be used instead of or in addition to light 20. Even an infrared light 20 or some light or other signal not visible to humans might be used to send a signal that is then detected by use of a known detection device.

It is further contemplated that airflow monitor 10 would remain inactive until remotely triggered to function by way of a remote control not shown.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A vacuum sewer system comprising:
at least one home collection system;
a central vacuum system coupled to the at least one home collection system; and
a vacuum valve monitoring system coupled to the home collection system, the vacuum valve monitoring system including:
an airflow detector; and
an indicator operatively coupled to the airflow detector, the indicator being configured to emanate an indication that the airflow detector has detected an airflow.

2. The vacuum sewer system of claim 1, wherein the home collection system includes a vent pipe, the vacuum valve monitoring system being coupled to the vent pipe.

3. The vacuum sewer system of claim 2, wherein the vacuum valve monitoring system is mounted through a wall of the vent pipe.

4. The vacuum sewer system of claim 3, wherein the vent pipe has a portion that has approximately a 180 degree bend.

5. The vacuum sewer system of claim 4, wherein the vacuum valve monitoring system is mounted
through the wall of the vent pipe in the 180 degree bend portion.

6. The vacuum sewer system of claim 5, wherein the vacuum valve monitoring system is mounted approximately half way through the 180 degree bend.

7. The vacuum sewer system of claim 1, wherein the airflow detector has a movable portion that moves when air is passed thereby.

8. The vacuum sewer system of claim 7, wherein the indicator is a light that is illuminated when airflow is detected by the airflow detector.

9. The vacuum sewer system of claim 7, wherein the vacuum valve monitoring system further includes a delay circuit that causes the indicator to not emanate the indication unless the airflow detector has been activated continuously for more than a predetermined amount of time.

10. The vacuum sewer system of claim 9, wherein the predetermined amount of time is at least 30 seconds.

11. A vacuum valve monitoring system coupled to a home collection system of a vacuum sewer system, the vacuum valve monitoring system comprising:
an airflow detector; and
an indicator operatively coupled to the airflow detector, the indicator being configured to emanate an indication that the airflow detector has detected an airflow.

12. The vacuum valve monitoring system of claim 11, wherein the home collection system includes a vent pipe, the vacuum valve monitoring system being couplable to the vent pipe.

13. The vacuum valve monitoring system of claim 12, wherein the vacuum valve monitoring system is mountable through a wall of the vent pipe.

14. The vacuum valve monitoring system of claim 13, wherein the vent pipe has a portion that has approximately a 180 degree bend.

15. The vacuum valve monitoring system of claim 14, wherein the vacuum valve monitoring system is mountable through the wall of the vent pipe in the 180 degree bend portion.

16. The vacuum valve monitoring system of claim 15, wherein the vacuum valve monitoring system is mountable approximately half way through the 180 degree bend.

17. The vacuum valve monitoring system of claim 11, wherein the airflow detector has a movable portion that moves when air is passed thereby.

18. The vacuum valve monitoring system of claim 17, wherein the indicator is a light that is illuminated when airflow is detected by the airflow detector.

19. The vacuum valve monitoring system of claim 17, wherein the vacuum valve monitoring system further includes a delay circuit that causes the indicator to not emanate the indication unless the airflow detector has been activated continuously for more than a predetermined amount of time.

20. The vacuum valve monitoring system of claim 19, wherein the predetermined amount of time is at least 30 seconds.
